(19) United States
(12) Patent Application Publication
(10) Pub. No.: US 2021/0114218 A1
(43) Pub. Date: Apr. 22, 2021

(54) METHOD AND SYSTEM FOR CONTROLLING ROBOT BASED ON PERSONAL AREA ASSOCIATED WITH RECOGNIZED PERSON

(71) Applicants: NAVER CORPORATION, Seongnam-si (KR); NAVER LABS CORPORATION, Seongnam-si (KR)

(72) Inventors: Seoktae KIM, Seongnam-si (KR); Kahyeon KIM, Seongnam-si (KR); Seijin CHA, Seongnam-si (KR)

(21) Appl. No.: 17/072,325

(22) Filed: Oct. 16, 2020

(30) Foreign Application Priority Data
Oct. 16, 2019 (KR) 10-2019-0128230

(51) Int. Cl. B25J 9/16; B25J 11/00; B25J 13/08

(52) U.S. Cl. CPC B25J 9/1676; B25J 9/1666; B25J 13/089; B25J 11/008; B25J 9/1651

(57) ABSTRACT

A robot control method includes recognizing a personal area associated with a person present in a traveling direction of a robot and controlling a movement of the robot based on the recognized personal area so that the robot avoids interference with the person. The personal area is differently recognized based on at least one of information on a country or a cultural area associated with the person, a moving direction of the person, a moving speed of the person, body information of the person, information on the path along which the person moves, a distance between the person and the robot, the type of service provided by the robot, the type of robot, and a speed of the robot.

### CROSS-REFERENCE TO RELATED APPLICATION

This application claims priority under 35 U.S.C. § 119 to Korean Patent Application No. 10-2019-0128230 filed on Oct. 16, 2019, which is incorporated herein by reference in its entirety.

### BACKGROUND OF THE INVENTION

### Field of Invention

The following description relates to a method and a system for controlling a robot and, more particularly, to a method and a system for controlling a robot by taking into consideration a personal area recognized in association with a person.

### Description of the Related Art

An autonomous driving robot is a robot that autonomously finds an optimum path to a destination using wheels or legs, while looking around the surroundings and detecting obstacles, and is developed and used for various fields, such as an autonomous driving vehicle, logistics, hotel services, and robot cleaners.

A robot used to provide a service within a building operates within an environment in which the robot is present along with a user who uses a space in a building (e.g., an employee working in a building and a staff or person who passes in a building). Accordingly, there is a case where the robot collides against such a user while moving (or traveling) in order to provide a service. Such a collision between a robot and a user makes the provision of a service by the robot very inefficient, and may cause a risk for the user who collides against the robot. Furthermore, from a standpoint of a user, the approach of the robot to the user may be recognized as a threat.

Accordingly, in using a robot for a service provision, there is a need for a robot control method and system for controlling a movement of a robot so that the robot is not recognized as a threat to a user while preventing a collision between the robot and the user and making the provision of a service by the robot more efficient.

Korean Patent Application Publication No. 10-2005-0024840 is a technology related to a path planning method for an autonomous mobile robot, and discloses a method of planning an optimum path, wherein a mobile robot autonomously moving at home or in an office can move to a target point safely and rapidly while avoiding an obstacle.

Information described above is intended to merely help understanding the invention, may include contents that do not form part of a conventional technology, and may not include contents of a conventional technology which may be presented to a person skilled in the art.

### BRIEF SUMMARY OF THE INVENTION

Embodiments of the present invention may provide a robot control method for controlling a movement of a robot so that the robot recognizes a personal area associated with a person present in a traveling direction of the robot and avoids interference with the person based on the recognized personal area of the person.

Furthermore, embodiments may provide a method of controlling a robot so that the robot outputs an indicator, including information that guides a movement of a person, information indicative of a feeling (i.e., an emotion) of the robot for a person, and information indicative of a movement of the robot, in controlling a movement of the robot.

Furthermore, embodiments may provide a method of controlling a robot by taking into consideration a person or other obstacle present in a crossover section or a corner, if a moving path of the person and a travel path of the robot in a building intersect each other or if the robot travels around a corner.

In an aspect, there is provided a robot control method performed by a robot or a robot control system controlling the robot, including recognizing a personal area associated with a person present in a traveling direction of a robot, and controlling a movement of the robot based on the recognized personal area so that the robot avoids interference with the person.

A personal area may be recognized as a circle having the person as its center when the person stops, and may be recognized as a cone or oval extending in the direction in which the person moves when the person moves.

Recognizing the personal area may include differently recognizing the personal area associated with the person based on at least one of information on a country or a cultural area associated with the person, a moving direction of the person, a moving speed of the person, body information of the person, information on the path along which the person moves, a distance between the person and the robot, the type of service provided by the robot, the type of robot, and a speed of the robot.

The length of the personal area extending in the direction in which the person moves may be increased as the speed of the person becomes greater, the height of the person becomes greater, or the width of the path along which the person moves becomes smaller.

The length of the personal area extending in the direction in which the person moves may be increased as the speed of the robot becomes higher in the direction in which the person is located, the height or width of the robot becomes greater, or a degree of a risk to the person attributable to a service provided by the robot becomes higher.

Controlling the movement of the robot may include controlling the movement of the robot so that the robot does not enter the personal area and passes by the path along which the person moves.

Controlling the movement of the robot may include controlling the movement of the robot so that the robot is decelerated when the robot approaches the personal area.

Controlling the movement of the robot may include when it is determined that it is impossible to pass through the path without entering the personal area or a width of the path is a given value or less, controlling the robot to wait on one side of the path in a state in which the robot stops, and controlling the robot to travel after the person passes by the robot.

The robot control method may further include recognizing an obstacle present in the traveling direction of the robot, determining whether the obstacle is a human being or a thing, and calculating a distance between the person and the robot and a moving speed of the person in the direction in which the robot is located when the obstacle is determined to be a human being. When the obstacle is determined to be the person, controlling the personal area and controlling the movement of the robot are performed. Controlling the movement of the robot may include determining an avoidance direction for avoiding the personal area, controlling the traveling direction of the robot and a speed of the robot so that the robot avoids the personal area, determining whether the personal area is avoided, and controlling the movement of the robot so that the robot moves to a destination of the robot if the personal area has been avoided or the person passes by the robot.

The robot control method may further include controlling the robot to output an indicator corresponding to a gaze of the robot at the person in at least one of cases including before the robot passes by the person in the path along which the person moves, while the robot passes by the person, and after the robots passes by the person. The indicator may include at least one of information that guides a movement of the person, information indicative of a feeling (i.e., an emotion) of the robot for the person, and information indicative of a movement of the robot.

Controlling the robot to output the indicator may include controlling the robot to output the indicator corresponding to the lowering of the gaze of the robot when a distance between the robot and the person is a given value or less or to output the indicator so that the gaze of the robot is directed toward a direction corresponding to a direction in which the robot tries to move.

Controlling the movement of the robot may include controlling the movement of the robot so that the robot does not pass through a space between the person and another person or an object, when it is determined that the person interacts with another person or an object, notifying the person that the robot will pass through the space or requesting the person to move by outputting at least one of a visual indicator and an auditory indicator to the person, when it is determined that the robot cannot pass by the person without entering the space, and controlling the movement of the robot so that the person passes by the robot.

Controlling the movement of the robot may include controlling the movement of the robot so that the robot avoids interference with the person or another person in a way to imitate an operation of the person avoiding interference with the other person, if at least part of the robot is included in the personal area and the robot needs to move along with the person.

The robot and the person may get on an elevator and get off the elevator. The robot may be controlled to get on the elevator after all persons get off the elevator, before the robot gets on the elevator. In the state in which the robot gets on the elevator, the robot may be controlled to move near to the wall of the elevator in order not to interrupt a person who gets on or gets off the elevator.

The robot control method may further include controlling the robot to output, at the rear of the robot, an indicator indicative of the deceleration or stop of the robot based on the control of the movement of the robot.

The robot control method may further include controlling the robot to be decelerated or stopped before the robot enters an intersecting section of a travel path when a moving path of the person and the travel path of the robot intersect each other within a building.

The robot control method may further include controlling a movement of the robot traveling around a corner based on predetermined surrounding environment information associated with the corner, if a travel path of the robot includes travelling around the corner within a building.

The surrounding environment information may include at least one of information on a shape of the corner, information on a space near the corner, and information on a population behavior pattern in the space near the corner. The information on the shape of the corner may include at least one of information on a width of a path constituting the corner, information on an angle of the corner, and information on a material of the corner. The information on the space near the corner may include at least one of information on utilization of the space near the corner and information on a distribution of obstacles near the corner. The information on the population behavior pattern in the space near the corner may include information on a moving pattern of a person in the space near the corner

In another aspect, there is provided a robot moving within a building, including at least one processor implemented to execute a computer-readable instruction. The at least one processor is configured to recognize a personal area associated with a person present in a traveling direction of a robot, and to control a movement of the robot based on the recognized personal area so that the robot avoids interference with the person.

### BRIEF DESCRIPTION OF THE DRAWINGS

FIG. 1 illustrates a method of controlling a robot to avoid interference with a user by considering a personal area associated with the user according to an embodiment.

FIG. 2 illustrating a block diagram of a robot that provides a service in a building according to an embodiment.

FIGS. 3 and 4 are block diagrams of a robot control system controlling a robot that provides a service in a building according to an embodiment.

FIG. 5 is a flowchart illustrating a method of controlling a robot to avoid interference with a user by considering a personal area associated with the user according to an embodiment.

FIG. 6 is a flowchart illustrating a method of controlling a robot if the robot cannot pass through the path along which a user passes without entering a personal area associated with the user according to an embodiment.

FIG. 7 is a flowchart illustrating a method of controlling a movement of a robot in an area/corner where a moving path of a user and a travel path of the robot intersect each other and a method of controlling a robot to output an indicator based on control of a movement of the robot according to an embodiment.

FIG. 8 illustrates a personal area associated with a user and a method of avoiding such a personal area according to an embodiment.

FIG. 9 illustrates a method of determining an avoidance direction for avoiding a personal area associated with a user according to an embodiment.

FIGS. 10A-10F illustrate indicators corresponding to gazes of a robot as indicators output by the robot according to an embodiment.

FIGS. 11A-11B, 12 and 13A-13C illustrate a method of controlling a robot if a user interacts with another user or an object according to an embodiment.

FIG. 14 illustrates a method of controlling a robot to avoid a personal area associated with a user according to an embodiment.

FIG. 15 illustrates a method of controlling a robot to avoid a personal area associated with a user if the width of a path is narrow according to an embodiment.

FIG. 16 illustrates a method of controlling a plurality of robots according to an embodiment.

FIG. 17 illustrates a method of controlling a robot in the use of an elevator according to an embodiment.

FIG. 18 illustrates a method of controlling a robot when the robot travels an area where a moving path of a user and a travel path of the robot intersect each other according to an embodiment.

FIG. 19 illustrates a method of controlling a robot when the robot travels around a corner according to an embodiment.

### DETAILED DESCRIPTION OF THE INVENTION

Hereinafter, embodiments of the present invention are described in detail with reference to the accompanying drawings.

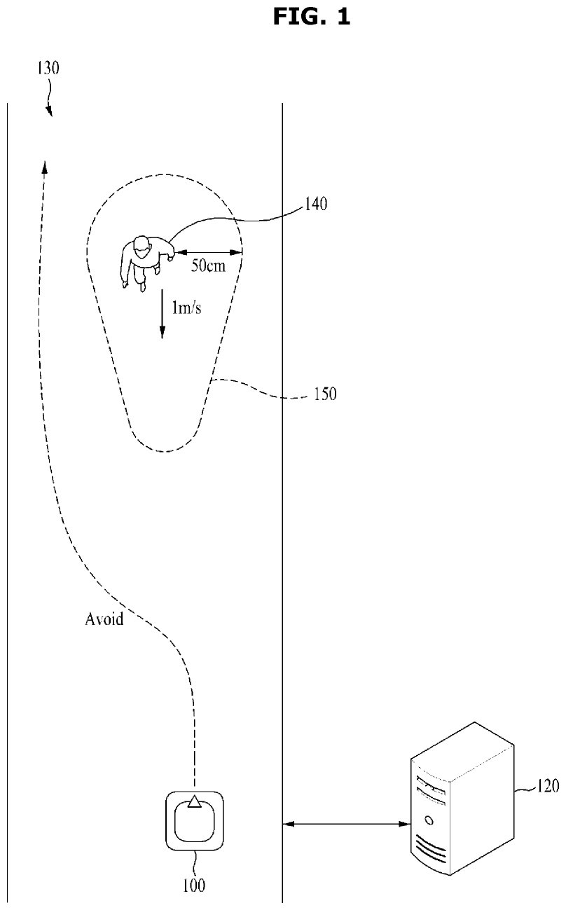

FIG. 1 illustrates a method of controlling a robot to avoid interference with a user by considering a personal area associated with the user according to an embodiment.

FIG. 1 illustrates a method of avoiding, by a robot 100 controlled based on control of a robot control system 120, a person 140 (hereinafter referred to as a “user 140”) present in a traveling direction of the robot 100 that travels along a given path in a building 130 (or a space in the building 130). The robot 100 may be a service robot that provides a service in the building 130 under the control of the robot control system 120. In the detailed description to be given, the space in the building 130 where the robot 100 provides a service may be denoted as the building 130, for convenience of description.

The building 130 is a space where a plurality of staff members (hereinafter referred to as “users or persons”) work or reside, and may include a plurality of partitioned spaces. Such spaces may be classified into the outer wall and window of the building 130 and a partition or a wall in the building 130. The robot 100 may travel the space in the building 130, and may provide a service at a given location in the building 130 (or to a given staff member). The user 140 is a staff member who moves within the building 130, and may freely move from one space to another space in the building 130.

The robot 100 may be a service robot used to provide a service in the building 130. The robot 100 may be configured to provide services in at least one floor of the building 130. Furthermore, the robot 100 may be plural. In other words, each of a plurality of robots may travel within the building 130, and may provide a service at a proper location or to a proper user in the building 130. In the detailed description to be given, the robot 100 may be denoted as indicating a plurality of robots, for convenience of description. The service provided by the robot 100 may include at least one of a parcel delivery service, a beverage (e.g., coffee) delivery service based on an order, a cleaning service, and other information/content provision services, for example.

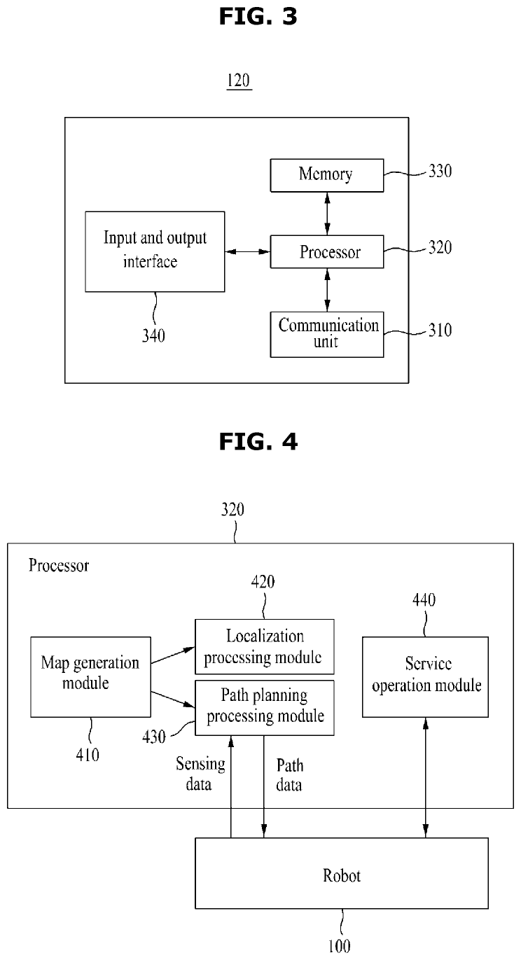

The robot 100 may provide a service at a given location of the building 130 through autonomous driving. The movement of the robot 100 and the provision of a service by the robot 100 may be controlled by the robot control system 120. The structure of the robot control system 120 is more specifically described with reference to FIGS. 3 and 4. The robot 100 may travel along a path set by the robot control system 120 and move to a given location or a given staff member. Accordingly, the robot 100 may provide a service at the given location or to the given staff member.

As illustrated in FIG. 1, the movement of the robot 100 needs to be controlled so that the robot does not interfere with (or collide against) the user 140 while the robot travels along the same path as the user 140.

In an embodiment, the robot 100 (or the robot control system 120 controlling the robot 100) may recognize a personal area 150 associated with the user 140 present in the traveling direction of the robot 100. The movement of the robot 100 (or the robot control system 120) may be controlled so that the robot avoids interference with the user 140 based on the recognized personal area 150. “Interference” between the user 140 and the robot 100 may embrace any kind of a situation in which a pass between the user 140 and the robot 100 is interrupted. For example, “interference” between the user 140 and the robot 100 may include a collision situation between the user 140 and the robot 100.

The personal area 150 associated with the user 140 may be differently configured based on at least one of a characteristic of the user 140, a characteristic of the robot 100, and a spatial characteristic of the path along which the user 140 moves within the building 130. For example, the personal area 150 may be configured in a form longer in the direction in which the user 140 moves if the user 140 moves (e.g., 1 m/s) in the direction in which the robot 100 is located.

The robot 100 (or the robot control system 120) may recognize and avoid the personal area 150 associated with the user 140. Accordingly, the robot 100 may perform an operation for avoiding the user 140 from a distance that is sufficiently distant to the extent that the user 140 may not feel threatened by the robot 100.

Accordingly, the possibility of interference (or a collision) between the robot 100 and the user 140 can be reduced. There is a less possibility that the user 140 may feel threatened by the approach of the robot 100.

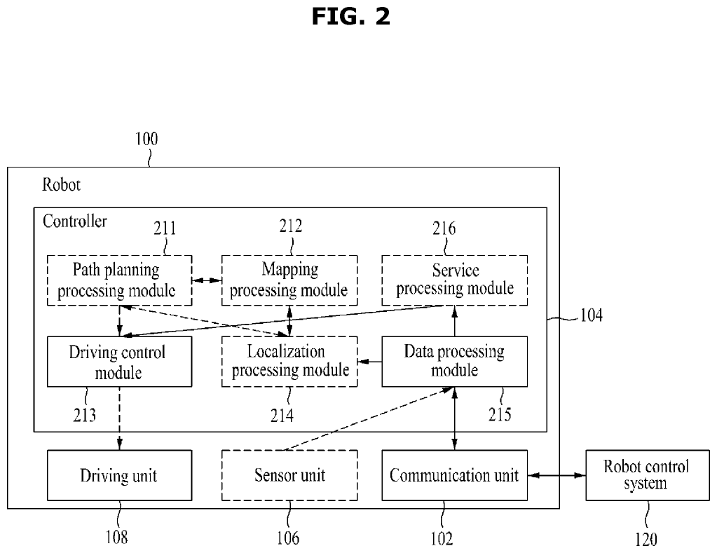

A more detailed method of controlling the robot 100 to avoid interference with the user 140 by considering the personal area 150 associated with the user 140 is described more specifically with reference to FIGS. 2 to 17.

FIG. 2 illustrates a block diagram of the robot 100 that provides a service in a building according to an embodiment.

As described above, the robot 100 may be a service robot used to provide a service in the building 130. The robot 100 may provide a service at a given location or to a given staff member in the building 130 through autonomous driving.

The robot 100 may be a physical device, and may include a controller 104, a driving unit 108, a sensor unit 106 and a communication unit 102, as illustrated in FIG. 2.

The controller 104 may be at least one physical processor embedded in the robot 100, and may include a path planning processing module 211, a mapping processing module 212, a driving control module 213, a localization processing module 214, a data processing module 215 and a service processing module 216. In some embodiments, the path planning processing module 211, the mapping processing module 212, and the localization processing module 214 may be optionally included in the controller 104 in order for indoor autonomous driving of the robot 100 to be performed although communication with the robot control system 120 is not performed. Each of the modules of the controller 104 may be a software and/or hardware module of the at least one physical processor, and may indicate a function block implemented by the processor based on control instructions according to a code of an operating system or a code of at least one computer program.

The communication unit 102 may be an element for enabling the robot 100 to communicate with another device (e.g., another robot or the robot control system 120). In other words, the communication unit 102 may be an antenna of the robot 100, a hardware module, such as a data bus, a network interface card, a network interface chip or a networking interface port, or a software module, such as a network device driver or a networking program, which transmits/receives data and/or information to/from another device.

The driving unit 108 is an element that controls the movement of the robot 100 and enables a movement, and may include equipment for the control.

The sensor unit 106 may be an element for collecting data necessary for autonomous driving of the robot 100 and necessary to provide a service by the robot. The sensor unit 106 may not include expensive sensing equipment, and may include a sensor, such as a cheap ultrasonic sensor and/or a cheap camera. The robot 100 may identify an obstacle located in a traveling direction thereof, and may identify whether such an obstacle is a thing or a person. The sensor unit 106 is a sensor for identifying such an obstacle/person located a traveling direction thereof, and may include at least one of a LiDAR, a stereo camera and a ToF sensor. Through such a device, the robot 100 may measure the distance between the obstacle/person and the robot 100. The robot 100 may determine whether a recognized obstacle is a human being or a thing based on image information obtained though the camera (or stereo camera). For example, the sensor unit 106 may include a stereo camera, but may not include a LiDAR that is relatively expensive. Furthermore, the sensor unit 106 may include a radar for identifying an obstacle/person. The robot 100 may obtain (or calculate) at least one of the distance between the user 140 and the robot 100, the direction toward which the body of the user 140 is directed, the direction in which the user 140 moves, and the speed of the user 140 based on data from the sensor unit 106. Furthermore, the sensor unit 106 may include a microphone as a sensor for detecting the sound of footsteps or the voice of the user 140, and may include an illuminance sensor for detecting a change in illuminance in the building 130, for example. Furthermore, the sensor unit 106 may include a collision sensor for detecting a physical collision against the robot 100.

The robot 100 i) may identify an obstacle located in a traveling direction thereof, ii) may identify whether such an obstacle is a thing or a person, and iii) may recognize the personal area 150 of the user 140, that is, a person, depending on the configuration of the sensor unit 106. At least one of the aforementioned i) to iii) may be performed by the robot control system 120 controlling the robot 120, not the robot 100. In such a case, the configuration of a sensor included in the sensor unit 106 may be simplified.

As a processing example of the controller 104, the data processing module 215 of the controller 104 may transmit, to the robot control system 120, sensing data including an output value of sensors of the sensor unit 106 through the communication unit 102. The robot control system 120 may transmit, to the robot 100, path data generated using an indoor map within the building 130. The path data may be delivered to the data processing module 215 through the communication unit 102. The data processing module 215 may directly transmit the path data to the driving control module 213. The driving control module 213 may control indoor autonomous driving of the robot 100 by controlling the driving unit 108 based on the path data.

If the robot 100 and the robot control system 120 cannot communicate with each other, the data processing module 215 may directly process indoor autonomous driving of the robot 100 by transmitting sensing data to the localization processing module 214 and generating path data through the path planning processing module 211 and the mapping processing module 212.

The robot 100 may be different from a mapping robot (not shown) used to generate an indoor map within the building 130. In this case, the robot 100 may process indoor autonomous driving using an output value of a sensor, such as a cheap ultrasonic sensor and/or a cheap camera, because the robot 100 does not include expensive sensing equipment typically installed in a mapping robot. When the robot 100 performs indoor autonomous driving through communication with the robot control system 120, cheap sensors can be used and more accurate indoor autonomous driving may be made because mapping data included in path data received from the robot control system 120 is used.

However, in some embodiments, the robot 100 may also play a role of a mapping robot.

The service processing module 216 may receive an instruction, received through the robot control system 120, through the communication unit 102 or the communication unit 102 and the data processing module 215. The driving unit 108 may further include equipment related to a service provided by the robot 100, in addition to equipment for a movement of the robot 100. For example, in order to perform a food and drink/delivery goods delivery service, the driving unit 108 of the robot 100 may include a configuration for loading food and drink/delivery goods or a configuration (e.g., a robot arm) for delivering food and drink/delivery goods to a user. Furthermore, the robot 100 may further include a speaker and/or a display for providing information/content. The service processing module 216 may transmit, to the driving control module 213, a driving instruction for a service to be provided. The driving control module 213 may control the robot 100 or an element included in the driving unit 108 based on the driving instruction so that the service is provided.

The robot 100 may travel a path set by the robot control system 120 based on control of the robot control system 120, and may provide a service at a given location or to a given staff member in the building 130. As described above, the robot 100 (i.e., the controller 104 of the robot 100) i) may identify an obstacle located in a traveling direction of the robot 100 while traveling, ii) may identify whether such an obstacle is a thing or a person, iii) may recognize the personal area 150 of the user 140, that is, a person, and iv) may control a movement of the robot 100 so that the robot avoids interference with the user 140 based on the recognized personal area 150.

At least one of the i) to iv) may be performed by the robot control system 120 not the robot 100. A configuration and operation of the robot control system 120 that controls the robot 100 are more specifically described with reference to FIGS. 3 and 4. In such a case, the robot 100 may correspond to a brainless robot in that it does not perform at least one of the i) to iv) and only provides sensing data for performing the i) to iv) to the robot control system 120.

The description of the technical characteristics described with reference to FIG. 1 may also be applied to FIG. 2 without any change, and thus a redundant description thereof is omitted.

FIGS. 3 and 4 are block diagrams of the robot control system 120 controlling the robot 100 that provides a service in a building according to an embodiment.

The robot control system 120 may be an apparatus for controlling the movement (i.e., traveling) of the robot 100 within the building 130 and the provision of a service by the robot 100 within the building 130. The robot control system 120 may control a movement of each of a plurality of the robots 100 and the provision of a service by each of the robots. The robot control system 120 may set a path through which the robot 100 provides a service through communication with the robot 100, and may transmit, to the robot 100, information on such a path. The robot 100 may travel based on the received information on the path, and may provide a service at a given location or to a given staff member. The robot control system 120 may control a movement of the robot 100 so that the robot moves (or travels) along the set path.

The robot control system 120 may be an apparatus for setting a path for the traveling of the robot 100 and the movement of the robot 100, as described above. The robot control system 120 may include at least one computing device, and may be implemented as a server located inside or outside the building 130.

As illustrated in FIG. 3, the robot control system 120 may include a memory 330, a processor 320, a communication unit 310, and an input and output interface 340.

The memory 330 is a computer-readable recording medium, and may include a random access memory (RAM), a read only memory (ROM), and a permanent mass storage device such as or a disk drive. In this case, the ROM and the permanent mass storage device may be separated from the memory 330 and may be included as a separate permanent storage device. Furthermore, an operating system and at least one program code may be stored in the memory 330. Such software elements may be loaded from a computer-readable recording medium different from the memory 330. Such a separate computer-readable recording medium may include computer-readable recording media, such as a floppy drive, a disk, a tape, a DVD/CD-ROM drive, and a memory card. In another embodiment, the software elements may be loaded onto the memory 330 through the communication unit 310, not computer-readable recording media.

The processor 320 may be configured to process an instruction of a computer program by performing basic arithmetic, logic, and input and output operations. The instruction may be provided to the processor 320 by the memory 330 or the communication unit 310. For example, the processor 320 may be configured to execute an instruction received based on a program code loaded onto the memory 330. The processor 320 may include elements 410 to 440, such as those illustrated in FIG. 4.

Each of the elements 410 to 440 of the processor 320 may be a software and/or hardware module as part of the processor 320, and may indicate a function block implemented by the processor. The elements 410 to 440 of the processor 320 are described later with reference to FIG. 4.

The communication unit 310 may be an element for enabling the robot control system 120 to communicate with another device (e.g., the robot 100 or another server). In other words, the communication unit 310 may be an antenna of the robot control system 120, a hardware module, such as a data bus, a network interface card, a network interface chip or a networking interface port, and a software module, such as a network device driver or a networking program, which transmits/receives data and/or information to/from another device.

The input and output interface 340 may be means for an interface with an input device, such as a keyboard or a mouse, and an output device, such as a display or a speaker.

Furthermore, in other embodiments, the robot control system 120 may include more elements than the illustrated elements.

The elements 410 to 440 of the processor 320 are described more specifically with reference to FIG. 4. As illustrated, the processor 320 may include a map generation module 410, a localization processing module 420, a path planning processing module 430, and a service operation module 440. The elements included in the processor 320 may be expressions of different functions performed by at least one processor included in the processor 320 based on control instructions according to a code of an operating system or a code of at least one computer program.

The map generation module 410 may be an element for generating the indoor map of a target facility (e.g., the building 130) using sensing data within the target facility, which is generated by a mapping robot (not illustrated) that autonomously travels within the building 130.

In this case, the localization processing module 420 may determine the location of the robot 100 within the target facility, using sensing data received from the robot 100 over a network and the indoor map of the target facility generated by the map generation module 410.

The path planning processing module 430 may generate a control signal for controlling indoor autonomous driving of the robot 100 using the sensing data received from the robot 100 and the indoor map generated by the map generation module 410. For example, the path planning processing module 430 may generate a path (i.e., path data) of the robot 100. The generated path (i.e., path data) may be set for the robot 100 for the traveling of the robot 100 along the corresponding path. The robot control system 120 may transmit, to the robot 100, information on the generated path over a network. For example, the information on the path may include information indicative of the current location of the robot 100, information for mapping the current location and the indoor map, and path planning information. The information on the path may include information on the path along which the robot 100 must travel in order to provide a service at a given location or to a given staff member within the building 130. The path planning processing module 430 may generate a path for the robot 100, and may configure the path for the robot 100. The robot control system 120 may control the movement of the robot 100 so that the robot 100 moves along such a set path.

By the aforementioned operations of the localization processing module 420 and the path planning processing module 430, the robot control system 120 may control the robot 100 that travels along a path set by the robot control system 120 so that the robot 100 i) identifies an obstacle located in the traveling direction of the robot 100, ii) identifies whether the obstacle is a thing or a person, iii) recognizes the personal area 150 of the user 140, that is, a person, and iv) avoids interference with the user 140 based on the recognized personal area 150. The robot control system 120 may control the robot 100 to perform at least one of the i) to iv). Control of the robot 100 not performed by the robot control system 120, among the i) to iv), may be performed by the robot 100 itself. For example, if communication (e.g., communication using the 5G network) between the robot 100 and the robot control system 120 can be performed at a high speed, control of at least one of the i) to iv) over the robot 100 may be performed by the robot control system 120. The robot 100 may not include an expensive sensor and can be reduced in weight and can be fabricated at a low price by increasing a processing portion in the robot control system 120.

The service operation module 440 may include a function for controlling a service provided by the robot 100 within the building 130. For example, the robot control system 120 or a service provider that operates the building 130 may provide an integrated development environment (IDE) for a service (e.g., cloud service) provided to a user or a producer of the robot 100 by the robot control system 120. In this case, the user or producer of the robot 100 may produce software for controlling a service provided by the robot 100 within the building 130 through the IDE, and may register the software with the robot control system 120. In this case, the service operation module 440 may control a service provided by the robot 100 using the software registered in association with the robot 100. As a detailed example, assuming that the robot 100 provides a service for delivering, to the location of a user, a thing (e.g., food and drink or parcel goods) requested by the user, the robot control system 120 may control the robot 100 to move to the location of the user by controlling indoor autonomous driving of the robot 100, and may transmit, to the robot 100, a related instruction so that the robot 100 delivers the thing to the user when arriving at an object location and provides a series of services.

The description of the technical characteristics described with reference to FIGS. 1 and 2 may also be applied to FIGS. 3 and 4 without any change, and thus a redundant description thereof is omitted.

In the detailed description to be given, operations performed by the elements of the robot control system 120 or the robot 100 may be described as operations performed by the robot control system 120 or the robot 100, for convenience of description.

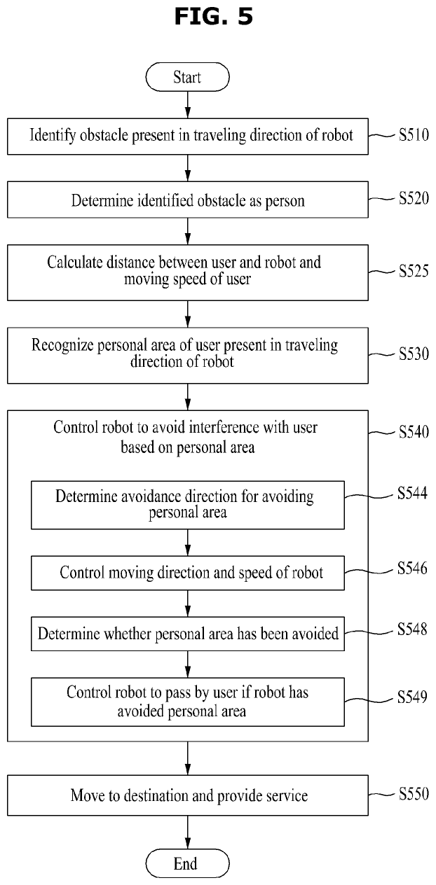

Steps to be described with reference to FIGS. 5 to 7 are described as being performed by the robot 100, for convenience of description, but as described above, at least some of operations to be described as being performed by the robot 100 including at least some of such steps may be performed by the robot control system 120 controlling the robot 100, and thus a redundant description thereof is omitted.

FIG. 5 is a flowchart illustrating a method of controlling the robot 100 to avoid interference with the user 140 by considering a personal area associated with the user according to an embodiment.

At step S510, the robot 100 may recognize an obstacle present in a traveling direction of the robot 100. The robot 100 may recognize an obstacle using a sensor included in the sensor unit 106. The obstacle 100 may include a thing within the building 130 or the structure of the building 130 itself within which the robot 100 travels, or the user 140 who moves within the building 130.

At step S520, the robot 100 may determine the recognized obstacle is a human being or a thing. If it is determined that the recognized obstacle is not a human being, but is a thing, the robot 100 may be controlled to avoid the obstacle according to a common obstacle avoidance method. Any type of an obstacle avoidance method may be applied, and a detailed description thereof is omitted. If it is determined that the recognized obstacle is a human being (i.e., determined as the user 140), the recognition of the personal area 150 associated with the user 140 and avoidance control of the robot 100 according to an embodiment may be performed. For example, the robot 100 may identify whether the recognized obstacle is a human being by analyzing image information obtained using a camera or stereo camera included in the sensor unit 106.

At step S525, if it is determined that the obstacle is the user 140, that is, a human being, the robot 100 may calculate the distance between the user 140 and the robot 100 and the moving speed of the user 140 in the direction in which the robot 100 is located. For example, the robot 100 may measure a distance between the user 140 and the robot 100 using a sensor included in the sensor unit 106, and may calculate an approaching speed of the user 140 based on a change in the distance.

At step S530, the robot 100 may recognize the personal area 150 associated with the user 140 present in the traveling direction of the robot 100. For example, the robot 100 may recognize the personal area 150 based on the distance between the user 140 and the robot 100 and the moving speed of the user 140 in the direction in which the robot 100 is located. For example, the robot 100 may differently recognize the personal area 150 associated with the user 140, based on at least one of information on a country or a cultural area associated with the user 140, a moving direction of the user 140, a moving speed of the user 140, body information of the user 140, information on the path along which the user 140 moves, a distance between the user 140 and the robot 100, the type of service provided by the robot 100, the type of robot 100, and the speed of the robot 100.

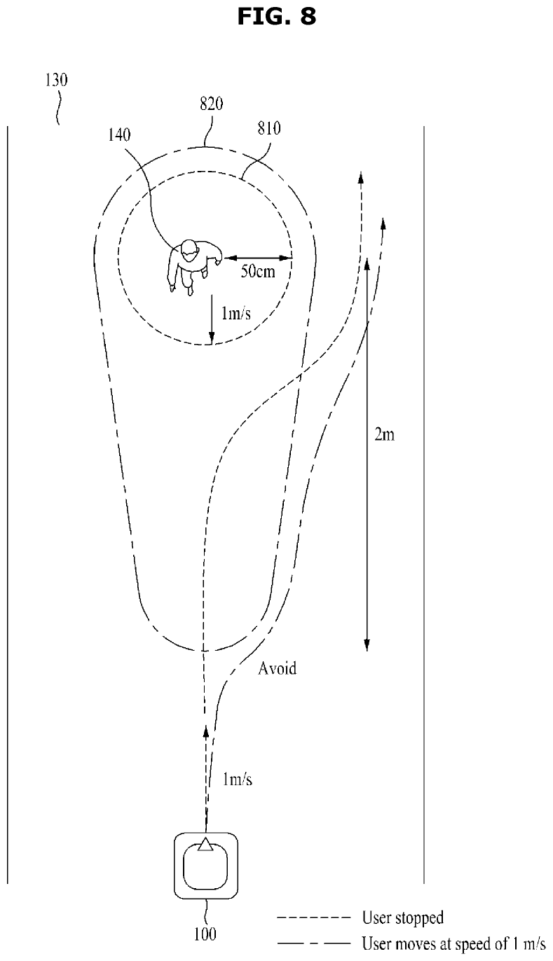

FIG. 8 illustrates personal areas 810, 820 associated with the user 140 according to an example. The personal areas 810, 820 may be differently configured based on at least one of a characteristic of the user 140, a characteristic of the robot 100, and a spatial characteristic of the path along which the user 140 moves within the building 130, and may indicate a space where the user 140 can feel at ease (without a feeling of threatening) with respect to the robot 100. When the robot 100 enters either of the personal areas 810, 820, the user 140 may feel uncomfortable due to a possibility of a collision with the robot 100 or a pass hindrance possibility attributable to the robot 100, for example. However, if the robot 100 travels outside the personal areas 810, 820, the user 140 may feel relatively less discomfort.

As illustrated in FIG. 8, the personal area 810 may be recognized as a circle having a given radius (e.g., 50 cm) around the user 140. That is, if the user 140 stops, the personal area 810 may be recognized as a circle having a given radius around the user 140. If the user 140 moves, the personal area 820 may be recognized as a cone (or an oval) that extends and becomes narrower in the direction in which the user 140 moves. For example, an extension (or a portion including the vertex of an extension/cone or oval) of the personal area 820, corresponding to the cone or the oval, may be located in front of the direction in which the user 140 moves. For example, if the user 140 moves in the direction in which the robot 100 is located, the personal area 820 may be recognized as a cone or oval whose vertex becomes distant from the user 140 toward the robot 100 (or as a cone or oval in which an extension of the personal area 820 is lengthened toward the robot 100). For example, as illustrated, if the user 140 moves at a speed of 1 m/s, a distance between the user and the vertex (i.e., an end portion of the extension) of the personal area 820 may be 2 m. If the personal area 820 is an oval, a vertex may be the vertex of the oval.

The size of the personal areas 810, 820 (i.e., the radius of the personal area 810 and/or a distance between the user 140 and a vertex in the personal area 820) may be increased as the (relative) speed of the user becomes greater in the direction in which the robot 100 is located. Furthermore, the size of the personal areas 810, 820 may be increased as the (relative) speed of the robot 100 that approaches the user 140 becomes greater. That is, when the user 140 rapidly moves or the robot 100 rapidly approaches, the user 140 may recognize the approach of the robot 100 as being more threatening. The increased size of the personal areas 810, 820 are appropriately set by the administrator of the robot control system 120.

Furthermore, the size of the personal areas 810, 820 may be different depending on information on a country or a cultural area (or on the building 130) associated with the user 140. For example, if the user 140 belongs to a country or a cultural area in which a contact with another user or being close to another user is treated as a slight taboo, the size of the personal area 810, 820 may be further increased. Such information on a country or a cultural area (or on the building 130) associated with the user 140 may be stored in the robot control system 120, or it may be stored in a database accessible to the robot 100 or the robot control system 120.

Furthermore, the personal area 150 may have a different shape depending on a moving direction of the user 140. For example, the personal area 150, like the personal area 820, may have a shape protruded in the direction in which the user 140 moves.

Furthermore, the size of the personal areas 810, 820 may be different depending on body information of the user 140. For example, if it is determined that the user 140 tends to be less adverse to the robot 100 (this may be noticed by the robot 100 or the robot control system 120 that obtains previously stored profile information of the user 140, for example), the size of the personal areas 810, 820 may be recognized to be smaller. Alternatively, if the user 140 is a male, the size of the personal areas 810, 820 may be recognized to be smaller compared to a case where the user 140 is a female. Alternatively, if height (or build) of the user 140 is great, the size of the personal areas 810, 820 may be recognized to be greater. If height of the user 140 is great, it may be predicted that a moving speed of the user 140 will be great. The size of the personal areas 810, 820 may be recognized to be greater. The profile information of the user 140 may be stored in the robot control system 120 or may be stored in a database accessible to the robot 100 or the robot control system 120.

Furthermore, if the width of the path along which the user 140 moves is smaller, the size of the personal areas 810, 820 may be recognized to be greater compared to a case where the width of the path along which the user 140 moves is greater. That is, the user 140 may recognize that meeting the robot 100 in a narrow path is more burdensome. Alternatively, if an object (e.g., a bulletin board or a computer which may be manipulated by the user 140) is positioned in the path along which the user 140 moves, the size of the personal areas 810, 820 may be recognized to be greater. Information related to the path along which the user 140 moves may be stored in the robot control system 120 or may be stored in a database accessible to the robot 100 or the robot control system 120.

Furthermore, the size of the personal areas 810, 820 may be differently recognized depending on the type of service provided by the robot 100 or the type of robot 100. For example, if the robot 100 provides a service for carrying large parcel goods or food and drink that are hot (or require pouring), the size of the personal areas 810, 820 may be recognized to be greater. Alternatively, if the robot 100 is capable of traveling at a high speed, the size of the personal areas 810, 820 may be recognized to be greater compared to a case where the robot 100 is incapable of traveling at a high speed.

Furthermore, the size of the personal areas 810, 820 may be differently recognized depending on a relative size difference (i.e., a difference in height and/or width) between the robot 100 and the user 140. For example, if the height of the user 140 compared to height of the robot 100 is a given value or less, the size of the personal areas 810, 820 may be increased so that the robot 100 can be decelerated sooner and can avoid the user 140 at a more distant location.

As described above, in the illustrated personal area 820, the length of the personal area 820 extending in the direction in which the user 140 moves may be increased as the speed of the user 140 becomes greater, as height of the user 140 becomes greater, or the width of the path along which the user 140 moves becomes smaller. In other words, a distance between the vertex (i.e., the end portion of the extension) of the personal area 820 and the user 140 may be increased as the speed of the user 140 in the direction in which the robot 100 is located becomes greater, as height of the user 140 becomes greater, or as the width of the path along which the user 140 moves becomes smaller.

Furthermore, the length of the personal area 820 extending in the direction in which the user 140 moves or the distance between the vertex and the user 140 may be increased as the speed of the robot 100 in the direction in which the robot 100 is located becomes greater, as the height or width of the robot 100 becomes greater, or as a degree of a risk of a service provided by the robot 100 with respect to the user 140 becomes higher.

At step S540, the robot 100 may control a movement of the robot 100 so that the robot avoids interference with the user 140 based on the recognized personal area 150. For example, a movement of the robot 100 may be controlled so that the robot does not enter the personal area 150 and passes by the user 140 (i.e., passes by the path along which the user 140 moves). For example, the robot 100 may be controlled to be decelerated when approaching the personal area 150. That is, the robot 100 may avoid the personal area 150 in a decelerated state.

As described above, the robot 100 can be decelerated sooner and can avoid the user 140 at a more distant location, as the size of the personal space 150 becomes greater. Furthermore, the robot 100 may avoid the user 140 who approaches more quickly, at a more distant location, and can avoid the user 140 who is stopped, at a closer location. FIG. 8 illustrates an example in which the robot 100 avoids the personal space 810, where the user 140 is stopped, at a location closer to the user 140 and avoids the personal space 820, where the user 140 moves, at a location distant from the user 140.

A user's feeling of threat from the robot 100 can be minimized because a movement of the robot 100 is controlled to avoid interference with the user 140 based on the personal area 150 at step S540.

Hereinafter, step S540 is described more specifically with reference to steps S544 to S549.

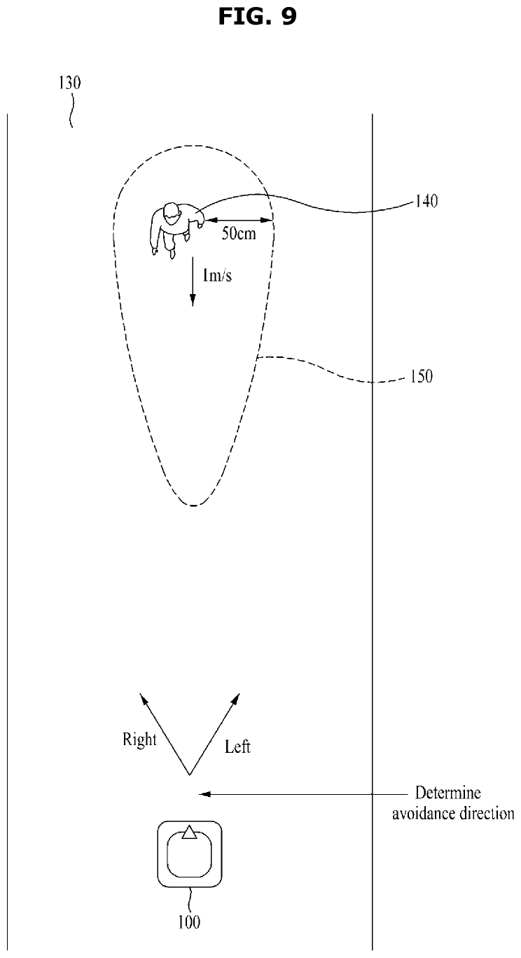

At step S544, the robot 100 may determine an avoidance direction for avoiding the personal area 150. For example, the robot 100 may control a movement of the robot 100 so that the robot avoids entering the personal area 150 in a preset direction of a left direction and a right direction, based on information on a country or a cultural area associated with the user 140. FIG. 9 illustrates a method of determining an avoidance direction for avoiding the personal area 150 associated with the user 140 according to an example. As illustrated, the robot 100 may determine an avoidance direction for avoiding the personal area 150 among the left direction and the right direction. For example, if the user 140 belongs to a country or a cultural area in which keeping to the right is followed (or if the building 130 belongs in a country or a cultural area in which keeping to the right is followed), the robot 100 may determine the right direction as an avoidance direction. Accordingly, in this case, the user 140 and the robot 100 may move in order not to violate the rule of “keeping to the right.” The user 140 may not have a sense of incompatibility with the robot 100.

At step S546, the robot 100 may control a moving direction of the robot 100 and the speed of the robot 100 so that the robot avoids the personal area 150. The robot 100 may be controlled to avoid the personal area 150 in a determined avoidance direction. Furthermore, the robot 100 may be decelerated prior to a given time before entering the personal area 150 or in front of a given distance from the personal area 150 by considering an approaching speed of the user 140 and the speed of the robot 100. Accordingly, the robot 100 may avoid the personal area 150 in the decelerated state.

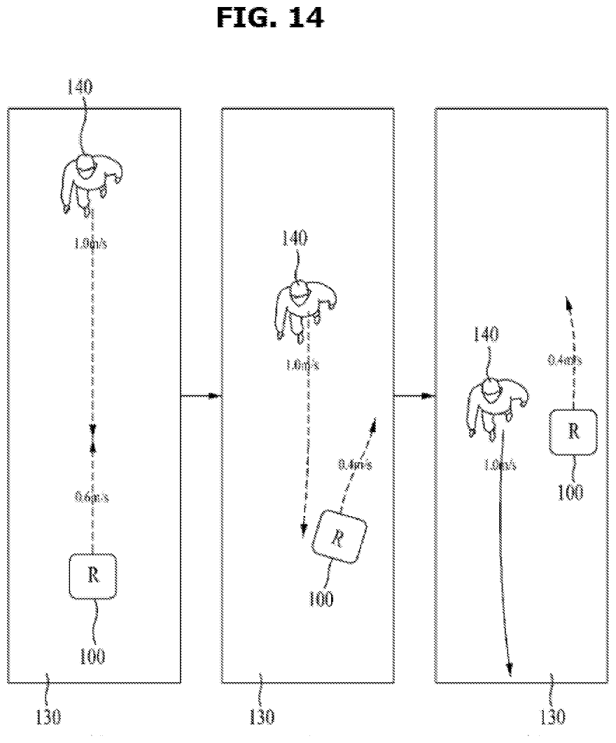

FIG. 14 illustrates a method of controlling the robot 100 to avoid the personal area 150 associated with the user 140 according to an example. The personal area 150 is not illustrated in FIG. 14. As illustrated, assuming that the user 140 moves at a speed of 1 m/s and the robot 100 moves at a speed of 0.6 m/s, it may be expected that the robot 100 and the user 140 may collide against each other if they move without any change. The robot 100 may move in the right direction, that is, a determined avoidance direction, and may be previously decelerated to a speed of 0.4 m/s in order not to invade the personal area 150 associated with the user 140. The robot 100 may pass by the user 140 in the decelerated state of 0.4 m/s.

At step S548, the robot 100 may determine whether the personal area 150 has been avoided. That is, the robot 100 may determine whether the avoidance of the personal area 150 is successful, while avoiding the personal area 150.

At step S549, if the robot 100 has avoided the personal area 150 (i.e., the avoidance is successful), a movement of the robot 100 may be controlled so that the robot 100 passes by the user 140. If the user 140 has passed by the robot 100, a movement of the robot 100 may be controlled to travel to a destination. The destination may be a location within the building 130 where the robot 100 will provide a service.

At step S550, the robot control system 120 may control the robot 100 to travel to a destination and to provide a service. If the robot 100 travels along a set path and reaches a location where a service will be provided, the robot control system 120 may control the robot 100 to provide a proper service.

At least some of steps S510 to S549, the control operation of the robot 100 and the operation of recognizing the personal area 150, performed by the robot 100, may also be performed by the robot control system 120. That is, the robot 100 may be controlled according to steps S510 to S549 based on a control signal from the robot control system 120, and a redundant description thereof is omitted.

The description of the technical characteristics described with reference to FIGS. 1 to 4 may also be applied to FIGS. 5, 8, 9 and 14 without any change, and thus a redundant description thereof is omitted.

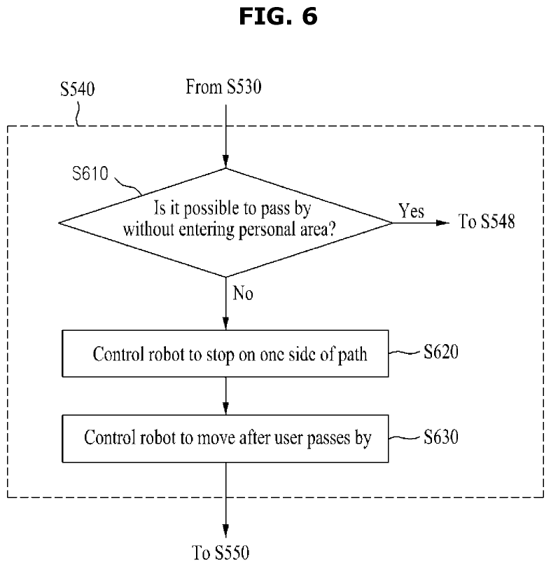

FIG. 6 is a flowchart illustrating a method of controlling a robot if the robot cannot pass through the path along which a user passes without entering a personal area associated with the user according to an example.

Hereinafter, step S540 is described more specifically with reference to steps S610 to S630.

At step S610, the robot 100 may determine whether it can pass by the user 140 without entering the personal area 150 associated with the user 140. Step S610 may correspond to step S548 described with reference to FIG. 5. For example, if the width of the path along which the user 130 travels is narrow, that is, a given value or less, the robot 100 may inevitably enter the personal area 150 associated with the user in order to pass through the path.

If it is determined that to pass by the user 140 (i.e., to pass through the path along which the user 140 moves) is impossible without entering the personal area 150 associated with the user 140 or the width of the path along which the user 140 moves is a given value or less, at step S620, the robot 100 may control itself to wait in a stopped state on one side of the path along which the user 140 moves.

At step S630, the robot 100 may be controlled to move after the user 140 passes by the robot 100. That is, if a path is narrow or the robot 100 inevitably invades the personal area 150 of the user 140, the robot 100 may wait on one side (i.e., wall) of the path without interrupting the pass of the user 140, and may travel after the user 140 moves by.

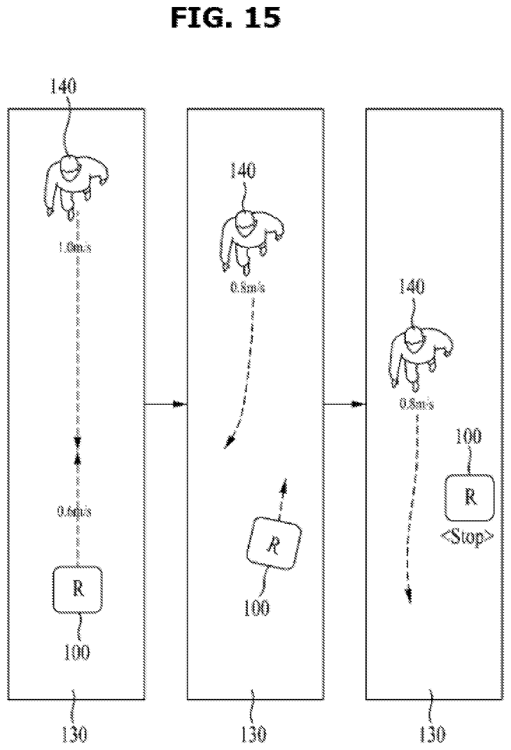

FIG. 15 illustrates a method of controlling the robot 100 to avoid the personal area 150 associated with the user 140 if the width of a path is narrow according to an example. The personal area 150 is not illustrated in FIG. 15. As illustrated, assuming that the user 140 moves at a speed of 1 m/s and the robot 100 moves at a speed of 0.6 m/s, it may be expected that the robot 100 and the user 140 collide against each other if they move without any change. The robot 100 may travel in the right direction, that is, a determined avoidance direction. The user 140 who has recognized the robot 100 may also reduce its moving speed to 0.8 m/s, and may move in the right direction so as to avoid the robot 100. Since the path is narrow, the robot 100 cannot pass through the path without invading the personal area 150 associated with the user 140. Accordingly, the robot 100 may stop in the state in which the robot is close to a wall on the right of the path, and may continue to travel after the user 140 fully passes by the robot 100.

At least some of steps S610 to S630 and the control operations performed by the robot 100 may also be performed by the robot control system 120. That is, the robot 100 may be controlled according to steps S610 to S630 based on a control signal from the robot control system 120, and a redundant description thereof is omitted.

The description of the technical characteristics described with reference to FIGS. 1 to 5, 8, 9 and 14 may also be applied to FIGS. 6 and 15 without any change, and thus a redundant description thereof is omitted.

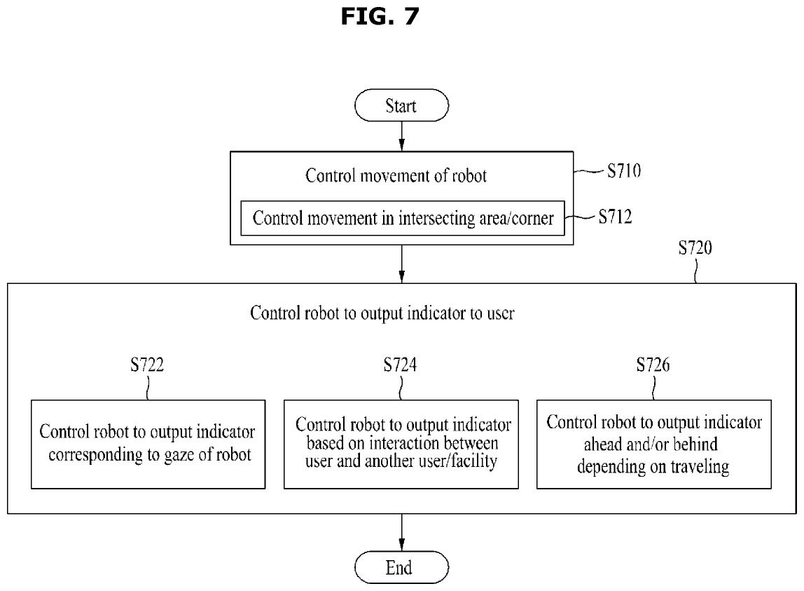

FIG. 7 is a flowchart illustrating a method of controlling a movement of the robot in an area (e.g., a corner) where a moving path of the user and a travel path of the robot intersect each other and a method of controlling the robot to output an indicator based on control of a movement of the robot according to an example.

At step S710, a movement of the robot 100 may be controlled in traveling along a path set by the robot control system 120.

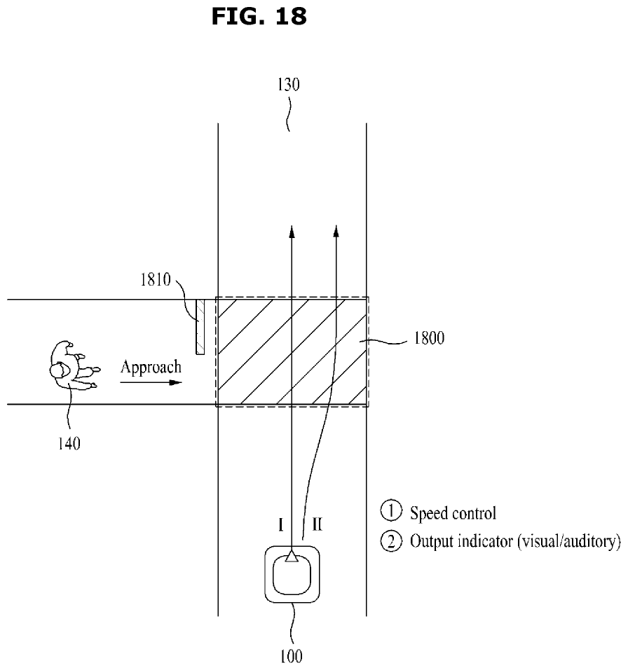

For example, when the robot 100 travels an area where the path along which the user 140 moves and the path along which the robot 100 travels intersect each other as in step S712, the speed of the robot 100 may be controlled. In relation to this example, FIG. 18 illustrates a method of controlling the robot 100 when the robot 100 travels an area 1800 in which the path along which the user 140 moves and the path along which the robot 100 travels intersect each other according to an example. If the path along which the user 140 moves and the path along which the robot 100 travels intersect each other within the building 130, the robot 100 may be controlled to be decelerated or stopped, before entering the area 1800 corresponding to the section of the intersecting travel path. That is, if the path along which the user 140 moves and the path along which the robot 100 travels intersect each other, the robot 100 may be proactively controlled to be decelerated or stopped because there is a good possibility that the user 140 will pass through the area 1800 corresponding to the section of the intersecting travel path.

The path along which the user moves may include a crossroad, an automatic door, a door or a corner, for example. FIG. 18 illustrates a case where an automatic door or door 1810 is disposed. When the automatic door or door 1810 is open (i.e., when a motion sensor installed in the automatic door 1810 detects that the user 140 approaches or when the locking device of the door 1810 is released), information indicative of the opening or release may be transmitted to the robot control system 120 (or the robot 100). In this case, the robot 100 may be controlled to be decelerated or stopped. Likewise, if a getting-on or getting-off area (i.e., an elevator door) in an elevator and the path along which the robot 100 travels intersect each other, when the elevator reaches the intersecting area, there is a good possibility that the user 140 will get off the elevator in the intersecting area. Accordingly, when the elevator is reached, the robot 100 may be controlled to be decelerated or stopped before entering the intersecting area.

Control information on an operation of the automatic door or door 1810, such as that described above, and control information on an operation of the elevator may be stored in the robot control system 120 or stored in a database accessible to the robot 100 or the robot control system 120, as surrounding environment information associated with the building 130.

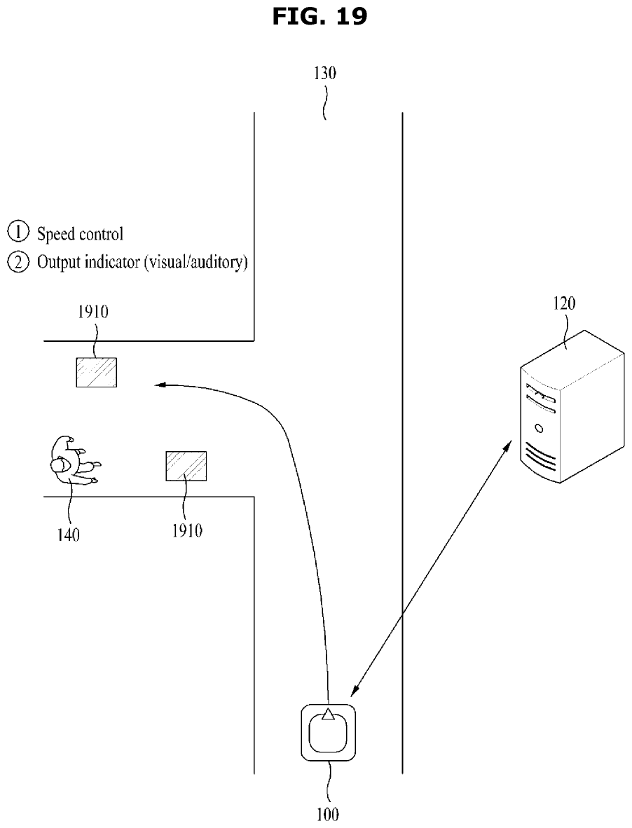

In another example, as in step S712, if the path along which the robot 100 travels within the building 130 includes travelling around a corner, a movement of the robot 100 that travels around the corner may be controlled based on the surrounding environment information. The surrounding environment information may include information associated with the corner around which the robot 100 will travel. FIG. 19 illustrates a method of controlling the robot 100 when travelling around a corner according to an example.

For example, the surrounding environment information may include at least one of information on a shape of the corner, information on a space near the corner, and information on a population behavior pattern in the space near the corner. In this case, the information on the shape of the corner may include at least one of information on the width of the corner (i.e., the width of a path that constitutes the corner), information on an angle of the corner, and information on a material of the corner (e.g., a material of a wall that constitutes the corner). Furthermore, the information on the space near the corner may include at least one of information on the utilization of the space near the corner and information on a distribution of obstacles near the corner. Furthermore, the information on the population behavior pattern in the space near the corner may include information on a moving pattern of a user in the space near the corner. The utilization of the space may be information indicative of utilization into which the possibility that users will pass through the space near the corner has been incorporated. Such utilization may be different depending on a time zone (e.g., an office-going time, a closing time, a lunch time or a task concentration time). When traveling around the corner, the robot 100 may be controlled by considering the utilization of a space in a time zone when the robot 100 travels.

Specifically, the robot 100 may be controlled to travel around the corner more slowly and more gently as the width of the corner becomes smaller. Furthermore, the robot 100 may be controlled to travel around the corner more slowly and more gently as an angle of the corner is smaller (if the angle is 0 degree, this may indicate a U-turn). If a material of the corner is a transparent material (e.g., if the wall of the corner is made of a material, such as transparent glass or acryl), the user 140 who enters the corner on an opposite side can be identified by the robot 100. Accordingly, if such a user 140 is not identified, the robot 100 may be controlled to travel around the corner at a relatively higher speed (i.e., without deceleration). Furthermore, the robot 100 may be controlled to travel around the corner more slowly as a population density in the space near the corner (in time zone when the robot 100 travels) becomes higher. Furthermore, the robot 100 may be controlled to travel around the corner more slowly as the number of obstacles 1910 in the space near the corner is increased. Furthermore, the robot 100 may be controlled to travel around the corner at a different speed depending on a population behavior pattern (i.e., whether users chiefly run, walk, move while watching something (e.g., a bulletin board), or stop) in the space near the corner. If users show a population behavior pattern in which the users chiefly run or move while watching something or stop in order to watch something, the robot 100 may be controlled to travel around the corner more slowly.

The surrounding environment information may be obtained based on image information from CCTV (i.e., CCTV that photographs a space near the corner) around the corner, for example. Alternatively, the surrounding environment information may be obtained by learning and analyzing the utilization of the space in the building 130 in a time zone and/or a pattern of a population behavior pattern during a given period.

The surrounding environment information may be stored in the robot control system 120 or may be stored in a database accessible to the robot 100 or the robot control system 120. At least some of the surrounding environment information may be included in mapped indoor map information. For example, the mapped indoor map information may include information on the width and length of a path (corridor) within the building 130, information on a gradient of a path, information (e.g., location) related to a crossroad and a corner, information (e.g., location) related to a door/automatic door/stairs/elevator, and information on the unevenness of a floor surface (i.e., information indicating whether a floor surface is uneven or smooth).

A collision/interference between the user 140 and the robot 100 can be prevented as in a case where the robot 100 travels a section having a blind spot, such as a case where the path along which the user 140 moves and the path along which the robot 100 travels intersect each other or a case where the robot 100 travels around a corner, under the control of the robot 100 based on step S710 and S712.

More detailed examples of control of the robot 100 are as follows.

The robot 100 may travel in a preset direction (e.g., the right) without traveling in the middle of a path. If the robot 100 avoids the user 140, the robot 100 may travel on the left side and avoid the user 140, when another obstacle is present on the right side. If a space is not sufficient on the right and left sides, the robot 100 may stop so that the user 140 moves first. If the robot 100 stops or waits, the robot 100 may be closer to the wall so that the user 140 can pass by (i.e., the robot 100 gives way to the user 140). If the user 140 stops for a long time (e.g., for a given time or more), the robot 100 may avoid and pass by the user 140. When meeting the user 140 at a short distance ahead, the robot 100 may output an indicator (e.g., an indicator 1100 to be described later) indicative of a “surprise” or “deference.”

As illustrated in FIG. 18, if it is determined that the automatic door or door 1810 is open, the robot 100 may travel away from the open door by a corresponding range by considering the range in which the automatic door or door 1810 is open (or a range in which the automatic door or door 1810 is open and the user 140 enters or exits from the door). That is, as illustrated, the robot 100 may be controlled to be closer to the wall side opposite the automatic door or door 1810 and to travel along path (II).

At step S720, the robot 100 may be controlled by the controller 104 of the robot or the robot control system 120 to output a given indicator depending on a situation. The indicator output by the robot 100 may include a visual indicator and/or an auditory indicator. The indicator output by the robot 100 may include at least one of information that guides a movement of the user 140, information indicative of a feeling of the robot 100 for the user 140, and information indicative of a movement of the robot 100.

Accordingly, in an interaction in which the robot 100 passes by the user 140, the robot may be controlled in a way that is friendlier and courteous to the user 140 by simulating a well-mannered moving method that is expected by a person.

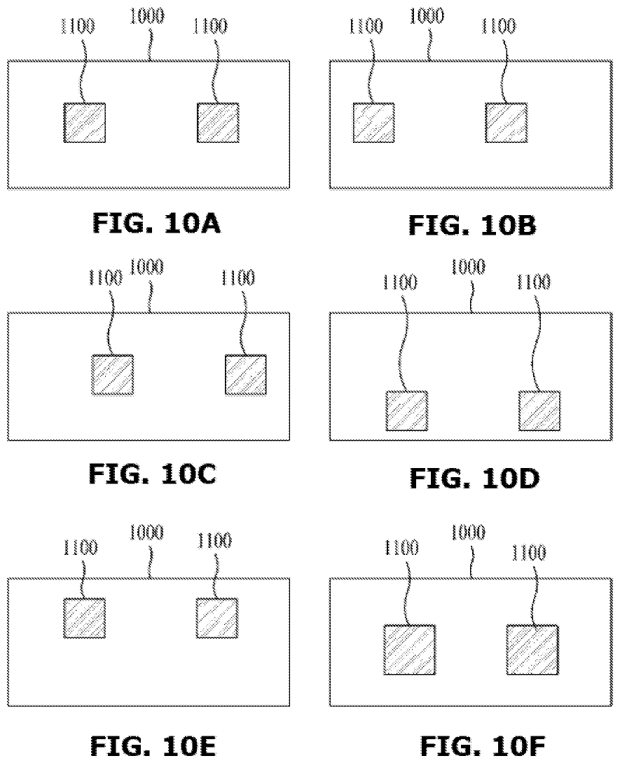

For example, as in step S722, the robot 100 may be controlled to output an indicator corresponding to a gaze of the robot 100. Before the robot 100 passes by the user 140 (i.e., before the user 140 passes through the path along which the user 140 moves), in at least one of a case, that is, while the robot 100 passes by the user 140, and a case, that is, after the user 140/robot 100 passes by the robot 100/user 140, the robot 100 may be controlled to output, to the user 140, an indicator corresponding to a gaze of the robot 100. The indicator corresponding to the gaze may correspond to an eye of the robot 100. FIGS. 10A-10F illustrate an indicator 1100, corresponding to a gaze of the robot 100, as an indicator output by the robot 100 according to an example. The robot 100 may include at least one display 1000. The indicator 1100 may be displayed on the display 1000. The robot 100 may indicate its intention for the user 140 in a way similar to an eye of a person through the indicator 1100. For example, when a distance between the robot 100 and the user 140 is a given value or less, the robot 100 may be controlled to output the indicator 1100 corresponding to the lowering of a gaze of the robot 100. Furthermore, the robot 100 may be controlled to output the indicator 1100 so that a gaze of the robot 100 is directed toward a direction corresponding to the direction in which the robot 100 tries to travel.

In detailed examples illustrated in FIGS. 10A-10F, FIG. 10A may indicate the indicator 1100 in the state in which the robot 100 commonly travels, and may indicate that the robot 100 gazes to the front. FIG. 10D may indicate the indicator 1100 for avoiding a gaze of the user 140 (look down) when the robot approaches the user 140 (e.g., within 2.5 m or less). The robot 100 may be controlled not to stare or gaze at the user 140 who passes by the robot, and may be controlled not to attract unnecessary attention from the user 140 by lowering its gaze down as much as possible when the robot is positioned at a distance close to the user 140. As in FIG. 10D, the robot 100 may not give a feeling of threat to the user 140 by lowering its gaze down. Furthermore, FIG. 10D may indicate the indicator 1100 when the robot 100 offers an apology or seeks understanding to the user 140. FIG. 10B and FIG. 10C may indicate the indicators 1100 when the robot 100 moves (or rotates) to the left and the robot 100 moves (or rotates) to the right, respectively. That is, a nearby user 140 may recognize the direction in which the robot 100 tries to travel by identifying a gaze direction of the robot 100. FIG. 10E may indicate the indicator 1100 (look up) when the robot 100 requests something from the user 140 or when the robot 100 indicates an intention. FIG. 10F may indicate the indicator 1100 (pupil dilatation) when the robot 100 is surprised.

Specifically, when the robot 100 encounters the user 140 at a close distance, the robot may indicate an apology to the user 140 by lowering its gaze down (look down) after the eyes of the robot 100 and the user 140 are met (look up) (FIG. 10a->FIG. 10C->FIG. 10D). If the user 140 blocks the way of the robot 100 and does not clear the way for a given time or more, the robot 100 may request the user 140 to clear the way by looking up at the user 140 (so that the robot 100 can pass by the user 140) (FIG. 10A->FIG. 10E). If the user 140 clears the way that blocks the robot 100 and thus the robot 100 can pass by the user 140, the robot 100 may indicate a happy feeling along with delighted gaze processing (FIG. 10E->FIG. 10F). For example, the happy feeling may be indicated by repeating the eye movements or gazes shown FIG. 10A and FIG. 10F (i.e., repeats the indicator 1100 (dilation and reduction of a pupil). When the robot 100 waits for the user 140 to pass by, the robot may lower its gaze down (look down and politely wait). After the user 140 passes by the robot 100, the robot may gaze at the front again (FIG. 10D->FIG. 10A.

As described above, non-verbal communication between the robot 100 and the user 140 can be reinforced using the indicator 1100 that imitates a gaze of a person.

Furthermore, for example, as in step S724, the robot 100 may be controlled to output an indicator based on an interaction between the user 140 and another user or an object (or facility). If it is determined that the user 140 interacts with another user or an object, the robot 100 may be controlled not to pass through the space between the user 140 and the other user or the object. In this case, if it is determined that the robot cannot pass by the user 140 without passing through the space between the user and the other user or an object, the robot 100 may notify the user 140 that the robot 100 will pass through the space by outputting at least one of a visual indicator and an auditory indicator to the user 140, and may be controlled to pass through the space. Alternatively, if it is determined that the robot 100 cannot pass by the user 140 without passing through the space, the robot 100 may request the user 140 to move, and may pass by the user 140 after the user 140 moves. An object may be a bulletin board, a kiosk device or a signage device installed within the building 130 or an electronic device within the building 130 which may be used by the user. If the user 140 makes a call while watching the wall of the building 130 or stands while simply watching the wall, the robot 100 may be controlled to act in a manner as in a situation where a user is interacting with an object.

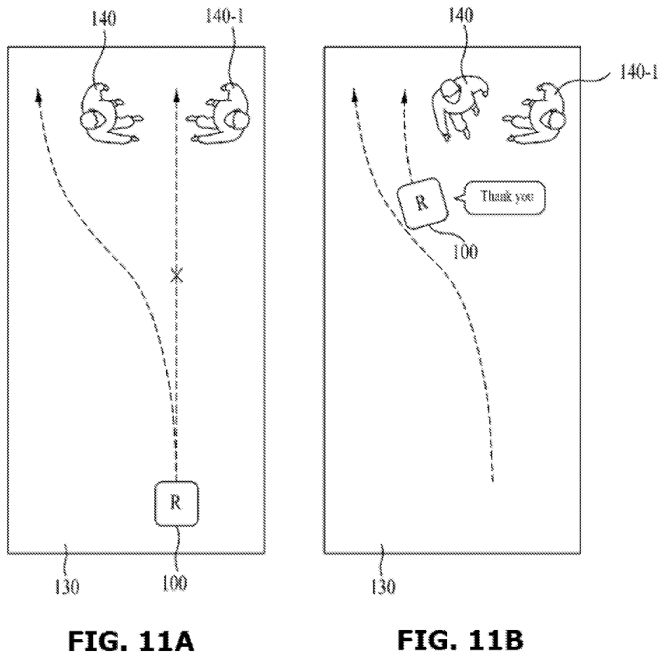

FIGS. 11A-11B, 12 and 13A-13C illustrate methods of controlling the robot 100 if the user 140 interacts with another user 140-1 or an object 1300 according to embodiments.

As illustrated in FIGS. 11A-11C, if the user 140 interacts with another user 140-1, the robot 100 may be controlled to travel without crossing the space between the user 140 and the other user 140-1. As in FIG. 11B, if the user 140 clears the way, the robot 100 may thank the user 140 by outputting an auditory indicator (e.g., “Thank you”). The robot 100 may also thank the user 140 in a nonverbal manner through the indicator 1100.

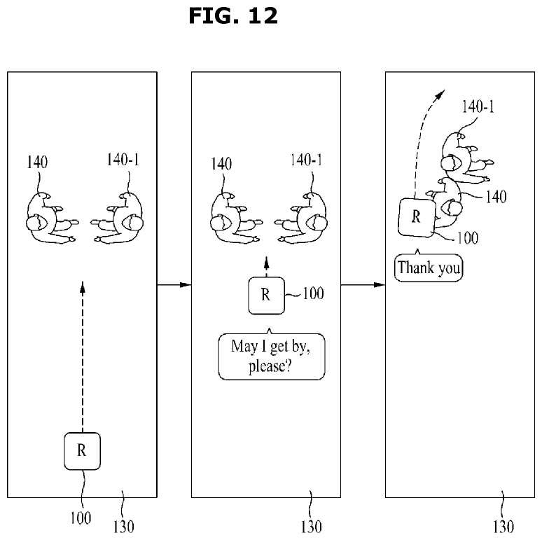

As illustrated in FIG. 12, if the user 140 interacts with the another user 140-1, if the robot 100 cannot travel without crossing the space between the user 140 and the other user 140-1, the robot 100 may seek understanding for interrupting the interaction between the user 140 and the other user 140-1. For example, as in the second portion of FIG. 12, the robot 100 may output a verbal indicator, such as “May I get by, please?” If the robot 100 can pass by because the users 140 and 140-1 provide a space around the users as in the third portion of FIG. 12, the robot 100 may output an indicator, such as “Thank you.” The robot 100 may also express its gratitude or seek understanding in a nonverbal manner through the indicator 1100. Furthermore, unlike in the example illustrated in the third portion of FIG. 12, the robot 100 may pass through the space between the user 140 and the other user 140-1, after seeking understanding.

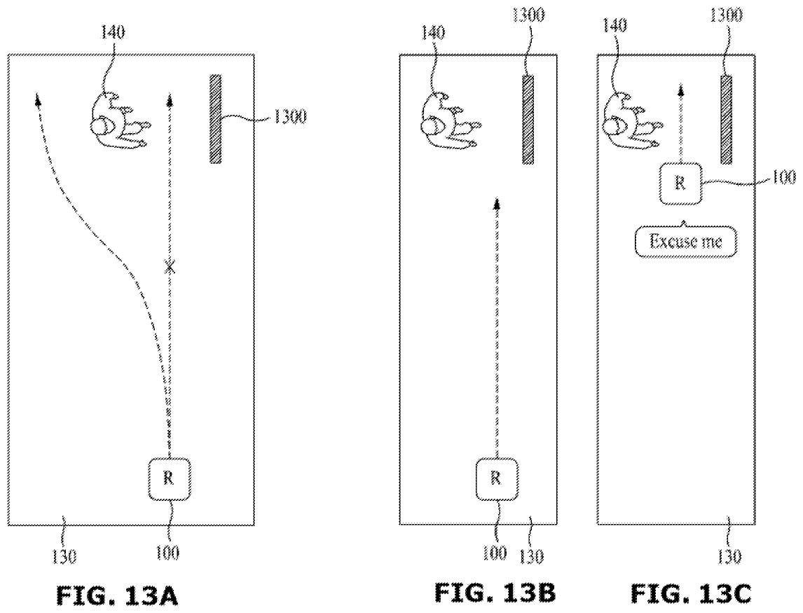

As illustrated in FIG. 13, if the user 140 interacts with an object 1300, the robot 100 may be controlled not to cross the space between the user 140 and the object 1300. If the robot 100 cannot travel without crossing the space between the user 140 and the object 1300, the robot 100 may seek understanding for interrupting the interaction between the user 140 and the object 1300. For example, as in FIG. 13C, the robot 100 may output a verbal indicator, such as “Excuse me.” Thereafter, the robot 100 may cross the space between the user 140 and the object 1300. Furthermore, the robot 100 may output an indicator, such as “Thank you.” The robot 100 may also express gratitude or seek understanding in a nonverbal manner through the indicator 1100. Furthermore, unlike in the example illustrated in FIG. 13C, if the user 140 clears the way for a movement of the robot 100, the robot 100 may travel through the cleared way.

The robot 100 may have to cross the space between the user 140 and the other user 140-1 or the object 1300 only when the path along which the robot 100 must travel is narrow (i.e., if the robot 100 cannot travel by avoiding the space).

Furthermore, for example, as in step S726, the robot 100 may be controlled to output an indicator ahead of and/or behind itself, depending on the direction of travel relative to the user. For example, when traveling, the robot 100 may output an indicator ahead of itself. This may correspond to the headlight of a vehicle. Accordingly, the user 140 in front of the robot 100 may recognize that the robot 100 approaches. Furthermore, the robot 100 may be controlled to output, at the rear of the robot 100, an indicator indicative of the deceleration or stop of the robot 100 under control of a movement of the robot 100. This may correspond to a brake light of a vehicle. Accordingly, the user 140 at the rear of the robot 100 may recognize that the robot 100 is decelerated and may stop in emergency. An indicator output from the front and/or rear of the robot 100 may maintain proper brightness so that a pedestrian's attention is not disturbed due to too high brightness or the robot cannot be recognized due to too low brightness.

Furthermore, while traveling, the robot 100 may output an ambient sound (e.g., a motor sound or a wheel-running sound), for example, as an auditory indicator. Alternatively, while traveling, the robot 100 may output a beep sound as an auditory indicator. Alternatively, the robot 100 may output a sound similar to a klaxon, as an auditory indicator, ahead of a blind spot (e.g., before entering the area 1800 in FIG. 18 or before entering the corner in FIG. 19). Accordingly, although the user 140 is located in the blind spot, the user 140 may recognize the approach of the robot 100 by recognizing such an auditory indicator of the robot 100. The volume of the auditory indicator may be properly adjusted so that the user 140 is not surprised.

Alternatively, a soft light and an exciting melody as a visual/auditory indicator may be used to indicate a happy feeling of the robot 100 or a grateful feeling for the user 140. In contrast, a flash and a piercing sound as a visual/auditory indicator may be used to indicate the path of the robot 100 for the user 140.

As described above, the robot 100 may imitate a polite and well-mannered person by outputting a proper indicator. Accordingly, the user 140 may not have a feeling of threat related to the approach of the robot 100.

At least some of the control of the movements of the robot 100 and the output control of the indicators of the robot 100 performed in steps S710 to S726 may be performed by the robot control system 120. That is, the robot 100 may be controlled according to steps S710 to S726 based on control signals from the robot control system 120. Alternatively, at least some of the control of the movements of the robot 100 and the output control of the indicators of the robot 100 performed in steps S710 to S726 may be performed by the robot 100 itself.

The description of the technical characteristics described with reference to FIGS. 1 to 6, 8, 9, 14 and 15 may also be applied to FIGS. 7, 10 to 13, 18 and 19 without any change, and thus a redundant description thereof is omitted.

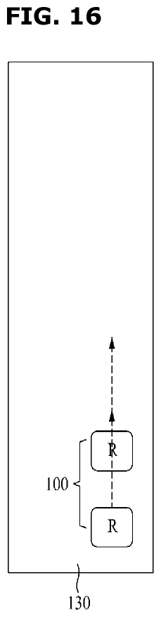

FIG. 16 illustrates a method of controlling a plurality of robots according to an example.

As illustrated, there may be a case where a plurality of the robots 100 may travel together for the provision of a service. In this case, the robots 100 may be controlled to travel longitudinally in a line, without travelling transversely. That is, the robots 100 may travel so that a sufficient space where the user 140 can move is provided in a path.

The description of the technical characteristics described with reference to FIGS. 1 to 15, 18 and 19 may also be applied to FIG. 16 without any change, and thus a redundant description thereof is omitted.

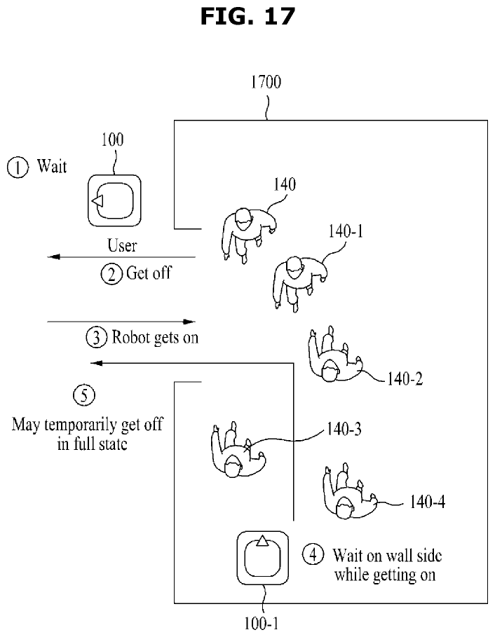

FIG. 17 illustrates a method of controlling the robot in the use of an elevator according to an example.

Even in controlling the movements of the robot 100 so that the robot avoids interference with the user 140 in step S540 described with reference to FIG. 5, there may be a case where at least part of the robot 100 is included in the personal area 150 associated with the user 140 and the robot 100 travels along with the user 140. In this case, the movements of the robot 100 may be controlled so that the robot avoids interference with the user 140 and other user(s) 140-1 to 140-4 in a way to imitate an operation of avoiding, by a person, interference with another person. For example, if the robot 100 gets on an elevator along with the user(s) 140-1 to 140-4, the robot 100 may be controlled to behave like a person being considerate to another person.

A case where at least part of the robot 100 is included in the personal area 150 associated with the user 140 and the robot 100 has to travel along with the user 140 may be where the robot 100 gets on the same elevator 1700 as the user 140 or gets off the elevator 1700 with the user 140, for example. In this case, the robot 100 may be controlled to get on the elevator 1700 after all users get off the elevator 1700, before getting on the elevator 1700. In the state in which the robot 100 has gotten on the elevator 1700, the robot 100 may be controlled to travel along the wall side of the elevator 1700 in order not to interrupt a user who gets on the elevator 1700 or gets off the elevator 1700.

Specifically, when waiting for the elevator 1700, the robot 100 may stand aslant from the door of the elevator 1700 and wait for the door to open (i.e., wait without blocking the door) in order not to interrupt a user who gets off the elevator 1700 (\textcircled{1}). Furthermore, if many users who wait for the elevator 1700 are present in the space where the users wait for the elevator 1700, the robot 100 may wait at the rear of the waiting users. When getting on the elevator 1700, the robot 100 may get on the elevator 1700 (\textcircled{3}) after all users who will get off the elevator 1700 get off the elevator 1700 (\textcircled{2}). When the robot 100 tries to get on the elevator 1700, if there is a user who tries to get off the elevator 1700, the robot 100 may move closer to the right or left in order to secure a space for the corresponding user. If a sufficient space is not secured although the robot 100 is closer to the right or left, the robot 100 may move backward. If the robot 100 moves backward, the robot may output an indicator (e.g., a visual/auditory indicator) indicative of the backward movement. In order to prevent a collision against a person or an obstacle, the robot 100 may rapidly move backward if a person or an obstacle is not present at the back of the robot and may slowly move backward if there is a person or an obstacle at the back of the robot. In the state in which the robot 100 has gotten on the elevator 1700, the robot may move close to the wall of the elevator 1700 in order not to interrupt a user who gets on or gets off the elevator 1700 (\textcircled{4}). The robot control system 120 may operate in conjunction with an elevator control system. Accordingly, if there is a user who tries to get on the elevator 1700, the robot 100 may, through the robot control system 120 in conjunction with the elevator control system, open the door of the elevator 1700 so that the door is not closed. Furthermore, in the state in which the elevator 1700 is full, if it is determined through its sensor unit 106 that another user (or an elderly or weak person or a disabled person (or wheelchair) tries to get on the elevator 1700, the robot 100 may secure a space for getting on the elevator by getting closer to the wall of the elevator 1700 or may yield the space for getting on the elevator by temporarily getting off the elevator (\textcircled{5}).

The robot 100 may exchange greetings with a user who gazes at the robot 100 within the elevator 1700. The greetings may be performed by the indicator 1100 or another visual/auditory indicator.

The description of the technical characteristics described with reference to FIGS. 1 to 16, 18 and 19 may also be applied to FIG. 17 without any change, and thus a redundant description thereof is omitted.

The aforementioned apparatus (or device) may be implemented as a hardware component, a software component and/or a combination of them. For example, the apparatus and elements described in the embodiments may be implemented using one or more general-purpose computers or special-purpose computers, for example, a processing apparatus or processor, a controller, an arithmetic logic unit (ALU), a digital signal processor, a microcomputer, a field programmable gate array (FPGA), a programmable logic unit (PLU), a microprocessor or any other device capable of executing or responding to an instruction. A processing apparatus (or processor) may perform an operating system (OS) and one or more software applications executed on the OS. Furthermore, the processing apparatus may access, store, manipulate, process and generate data in response to the execution of software. For convenience of understanding, one processing apparatus has been illustrated as being used, but a person having ordinary skill in the art may understand that the processing apparatus may include a plurality of processing elements and/or a plurality of types of processing elements. For example, the processing apparatus may include a plurality of processors or a single processor and a single controller. Furthermore, other processing configurations, such as a parallel processor, are also possible.

Software may include a computer program, code, an instruction or a combination of one or more of them and may configure a processor so that it operates as desired or may instruct processors independently or collectively. The software and/or data may be embodied in any type of a machine, component, physical device, virtual equipment, or computer storage medium or device so as to be interpreted by the processor or to provide an instruction or data to the processor. The software may be distributed to computer systems connected over a network and may be stored or executed in a distributed manner. The software and data may be stored in one or more computer-readable recording media.

The method according to the embodiment may be implemented in the form of program instructions executable by various computer means and stored in a computer-readable recording medium. The computer-readable recording medium may include a program instruction, a data file, and a data structure alone or in combination. The program instructions stored in the medium may be specially designed and constructed for the present disclosure, or may be known and available to those skilled in the field of computer software. Examples of the computer-readable storage medium include magnetic media such as a hard disk, a floppy disk and a magnetic tape, optical media such as a CD-ROM and a DVD, magneto-optical media such as a floptical disk, and hardware devices specially configured to store and execute program instructions such as a ROM, a RAM, and a flash memory. Examples of the program instructions include not only machine language code that is constructed by a compiler but also high-level language code that can be executed by a computer using an interpreter or the like.

The robot is controlled to avoid the personal area of a person which is differently recognized depending on at least one of information of a country or a cultural area associated with the person, the moving direction of the person, the moving speed of the person, body information of the person, information on the path along which the person moves, the distance between the person and the robot, the type of service provided by the robot, the type of robot, and the speed of the robot. Accordingly, a collision/interference between the person and the robot can be prevented, and the robot can be controlled so that the person does not feel threatened.

In controlling a movement of the robot, the robot is controlled to output an indicator including information that guides the movement of a person, information indicative of the feeling of the robot for the person or information indicative of the movement of the robot and to imitate a behavior pattern of a person. Accordingly, the robot can be recognized by the person to be friendly.

If the robot travels a section having a blind spot, such as a case where the moving path of a person and the travel path of the robot intersect each other within a building or a case where the robot travels around a corner, a collision/interference between the person and the robot can be prevented.

As described above, although the embodiments have been described in connection with the limited embodiments and drawings, those skilled in the art may modify and change the embodiments in various ways from the description. For example, proper results may be achieved although the above descriptions are performed in order different from that of the described method and/or the aforementioned elements, such as the system, configuration, device, and circuit, are coupled or combined in a form different from that of the described method or replaced or substituted with other elements or equivalents. Accordingly, other implementations, other embodiments, and equivalents of the claims fall within the scope of the claims.

What is claimed is:

1. A robot control method performed by a robot or a robot control system controlling the robot, comprising:
recognizing a personal area associated with a person present in a traveling direction of a robot; and
controlling a movement of the robot based on the recognized personal area so that the robot avoids interference with the person.

2. The robot control method of claim 1, wherein the personal area is recognized as a circle having the person as its center when the person stops and is recognized as a cone or oval extending in a direction in which the person moves when the person moves.

3. The robot control method of claim 2, wherein recognizing the personal area comprises differently recognizing the personal area associated with the person based on at least one of information on a country or a cultural area associated with the person, a moving direction of the person, a moving speed of the person, body information of the person, information on a path along which the person moves, a distance between the person and the robot, a type of service provided by the robot, a type of robot, and a speed of the robot.

4. The robot control method of claim 2, wherein a length of the personal area extending in the direction in which the person moves is increased as the speed of the person becomes greater, a height of the person becomes greater, or a width of the path along which the person moves becomes smaller.

5. The robot control method of claim 2, wherein a length of the personal area extending in the direction in which the person moves is increased as a speed of the robot becomes higher in a direction in which the person is located, a height or width of the robot becomes greater, or a degree of a risk to the person attributable to a service provided by the robot becomes higher.

6. The robot control method of claim 1, wherein controlling the movement of the robot comprises controlling the movement of the robot so that the robot does not enter the personal area and passes by a path along which the person moves.

7. The robot control method of claim 6, wherein controlling the movement of the robot comprises controlling the movement of the robot so that the robot is decelerated when the robot approaches the personal area.

8. The robot control method of claim 6, wherein controlling the movement of the robot comprises:
when it is determined that it is impossible to pass through the path without entering the personal area or a width of the path is a given value or less,
controlling the robot to wait on one side of the path in a state in which the robot stops; and
controlling the robot to travel after the person passes by the robot.

9. The robot control method of claim 1, further comprising:
prior to the recognizing of the personal area associated with the person, recognizing an obstacle present in the traveling direction of the robot;
determining whether the obstacle is a human being or a thing; and
calculating a distance between the person and the robot and a moving speed of the person in a direction in which the robot is located when the obstacle is determined to be the human being,
wherein controlling the movement of the robot comprises:
determining an avoidance direction for avoiding the personal area;
controlling the traveling direction of the robot and a speed of the robot so that the robot avoids the personal area;
determining whether the personal area is avoided; and
controlling the movement of the robot so that the robot moves to a destination of the robot if the personal area has been avoided or the person passes by the robot.

10. The robot control method of claim 1, further comprising controlling the robot to output an indicator corresponding to a gaze of the robot at the person in at least one of cases, including before the robot passes by the person in a path along which the person moves, while the robot passes by the person, and after the robots passes by the person,
wherein the indicator comprises at least one of information that guides a movement of the person, information indicative of a feeling of the robot for the person, and information indicative of a movement of the robot.

11. The robot control method of claim 10, wherein controlling the robot to output the indicator comprises controlling the robot to output the indicator corresponding to a lowering of the gaze of the robot when a distance between the robot and the person is a given value or less or to output the indicator so that the gaze of the robot is directed toward a direction corresponding to a direction in which the robot tries to move.

12. The robot control method of claim 1, wherein controlling the movement of the robot comprises:
controlling the movement of the robot so that the robot does not pass through a space between the person and another person or an object, when it is determined that the person interacts with the another person or the object,
notifying the person that the robot will pass through the space or requesting the person to move by outputting at least one of a visual indicator and an auditory indicator to the person, when it is determined that the robot cannot pass by the person without entering the space, and
controlling the movement of the robot so that the person passes by the robot.

13. The robot control method of claim 1, wherein controlling the movement of the robot comprises controlling the movement of the robot so that the robot avoids interference with the person or another person in a way to imitate an operation of the person avoiding interference with the another person, if at least part of the robot is included in the personal area and the robot needs to move along with the person.

14. The robot control method of claim 13, wherein when the robot and the person get on an elevator and get off the elevator, the robot is controlled to get on the elevator after all persons get off the elevator, before the robot gets on the elevator, and
in a state in which the robot gets on the elevator, the robot is controlled to move near to a wall of the elevator in order not to interrupt a person who gets on or gets off the elevator.

15. The robot control method of claim 1, further comprising controlling the robot to output, at a rear of the robot, an indicator indicative of a deceleration or stop of the robot based on the control of the movement of the robot.

16. The robot control method of claim 1, further comprising controlling the robot to be decelerated or stopped before the robot enters an intersecting section of a travel path when a moving path of the person and the travel path of the robot intersect each other within a building.

17. The robot control method of claim 1, further comprising controlling a movement of the robot traveling around a corner based on predetermined surrounding environment information associated with the corner, if a travel path of the robot includes travelling around the corner within a building.

18. The robot control method of claim 17, wherein:
the surrounding environment information comprises at least one of information on a shape of the corner, information on a space near the corner, and information on a population behavior pattern in the space near the corner,
the information on the shape of the corner comprises at least one of information on a width of a path constituting the corner, information on an angle of the corner, and information on a material of the corner,
the information on the space near the corner comprises at least one of information on utilization of the space near the corner and information on a distribution of obstacles near the corner, and
the information on the population behavior pattern in the space near the corner comprises information on a moving pattern of a person in the space near the corner.

19. A robot moving within a building, comprising:
at least one processor implemented to execute a computer-readable instruction,
wherein the at least one processor is configured to:
recognize a personal area associated with a person present in a traveling direction of a robot; and
control a movement of the robot based on the recognized personal area so that the robot avoids interference with the person.
